(19) United States
(12) Patent Application Publication
(10) Pub. No.: US 2011/0239559 A1
(43) Pub. Date: Oct. 6, 2011

(54) Internal Anchor Board-Up System

(76) Inventor: Howard Anthony Wedren, Chicago, IL (US)

(21) Appl. No.: 13/076,499

(22) Filed: Mar. 31, 2011

Related U.S. Application Data
(60) Provisional application No. 61/319,498, filed on Mar. 31, 2010.

(51) Int. Cl. E04B 1/92; E06B 9/00; E06B 3/30; E04G 23/02

(52) U.S. Cl. 52/202; 52/745.21; 52/514

(57) ABSTRACT

An internal anchor board-up system for windows is disclosed. The internal anchor board-up system may include an exterior window cover, one or more interior clamping beams, and bolts or fasteners connecting the cover to the beam. The exterior cover is preferably transparent, such as a plexiglass cover, so that the internal anchor board-up system is substantially more esthetically pleasing than traditional board-up systems relying upon plywood. Further, a transparent plexiglass or acrylic cover is stronger and harder to cut through than plywood.

### FIELD OF THE DISCLOSURE

A security closure is disclosed for use in covering openings in a building, for example windows or the like. More specifically, this disclosure relates to an internal anchor board-up system for windows.

### BACKGROUND OF THE DISCLOSURE

Ownership of buildings, particularly homes, often presents an attractive target for burglars or other persons attempting to make illegal entry or unwarranted entry into such buildings. The problem is particularly acute when the buildings are uninhabited either for a short or for a long period of time. The problem is even more acute in urban areas where a high rate of crime includes illegal entry into and burglary of buildings.

The problem of defending against such illegal entry and burglary becomes particularly acute when there are a large number of buildings involved spread out over a wide area. Placing a guard in every such building is expensive and impractical. Providing extensive and expensive burglar alarms doesn't solve the problem because burglar alarms allow the burglar or illegal entrant to gain initial access to the interior of a building. Whether he/she is subsequently frightened off by the alarm or by the rapid approach of police or other security officials, such an illegal entrance has already done damage to the property. What is worse, sometimes these alarm systems do not work properly in which no alarm is given, and therefore no deterrent is provided against the continued occupation by the illegal entrant.

A common alternative is the boarding up of houses that have become either abandoned or uninhabited for brief or long periods of time. The most common technique for boarding up a window involves nailing a plywood panel over the opening of the window, with the nails being driven through the plywood panel and into the outer frame or casing of the window. Obviously, this procedure damages the window frame, or at least various components of the window frame such as the side casings (side frame members), head casing (top frame member) and window sill. Another problem with this solution is that it is very easy for a determined burglar or illegal entrant to simply remove the boards and enter the building. This can be accomplished by merely using the claw end of a hammer, a crow bar, a screwdriver, or simply breaking the boards or sawing through them. Very little time is required for a determined illegal entrant to gain access to a building that is boarded up.

Further, the boarding up of windows is unsightly and can contribute to the decline in property values in poverty-stricken neighborhoods or neighborhoods experiencing large numbers of foreclosures or vacancies. The scope of this problem can be appreciated in certain urban areas where literally thousands of houses have been abandoned or condemned. Many of the boarded-up houses become burglarized or otherwise destroyed, and valuable materials removed to such an extent that the resultant values of the house and surrounding houses are reduced.

Further, some homeowners may feel insecure in leaving their homes even for a brief one or two week vacation because there is no readily available means of providing security to their homes in their absence to defend against illegal entry or burglary. Similarly, people owning summer homes and cottages remote from urban areas and which are uninhabited during most of the year may be desirous of an inexpensive and relatively easy way to secure windows. Many homeowners cannot afford expensive and elaborate burglar alarm systems, nor can they afford to hire a guard to stand on the premises during the time of their absence. Furthermore, burglar alarm systems are not appropriate for country homes that are remote from police or other security officials who would be notified by such burglar alarms and who could not reach such premises in sufficient time to prevent damage from an illegal entrant or burglar. However, boarding up windows, as indicated above, is ineffective against a determined illegal entrant or burglar, it damages the window and is very unsightly.

Accordingly, there is a need for an improved system for securing windows of abandoned buildings, unoccupied buildings or buildings that are occupied temporarily or seasonally. Such an improved system should provide a more aesthetically appealing appearance than plywood boarding and less damage to the structure of the window.

### SUMMARY OF THE DISCLOSURE

In satisfaction of the above needs, an internal anchor board-up system for a window is disclosed. The internal anchor board-up system may include an exterior window cover, an interior clamping beam, and fasteners connecting the cover and beam.

In a refinement, the exterior cover may be sized to fit within a window frame or it may be sized to fit over a window frame.

In a refinement, two clamping beams are utilized.

In another refinement, the exterior cover is transparent. Such a transparent material may be plexiglass or another suitable, durable and shatterproof material.

In a refinement, two clamping beams are used and are disposed parallel with respect to each other.

In another refinement, the clamping beams are used in a horizontal orientation.

In another refinement, each clamping beam includes two opposing ends. Each end includes a foot or support for engaging an interior surface in supporting the clamping beam above the interior surface. For example, a window frame member or a casing member might be damaged from clamping pressure imposed by the clamping beam. In this situation, clamping beams with feet or supports at either end can support the clamping beam above the interior frame or casing member, thereby avoiding damage to the interior of the window.

A kit for boarding windows is also disclosed. The kit includes a first exterior cover, first interior clamping beam and a plurality of fasteners for passing through a window pane or an opening in the event the window pane is broken and connecting the cover to the clamping beam.

In a refinement, the kit may include a second clamping beam. In a further refinement, the kit may include two exterior covers and two sets of clamping beams, for use with a double hung window.

A method for boarding up a window is also disclosed. The method includes providing exterior cover sized to cover the window opening with exterior edges of the cover disposed within the window frame or the exterior cover may be sized to cover the window frame. The method also includes providing a first interior clamping beam sized to be wider or longer than the window opening (or at least as wide or long as the window frame). The method also includes placing the exterior cover over the exterior of the window, placing the first interior clamping beam across the window and connecting the exterior cover to the clamping beam with a plurality of fasteners.

Other advantages and features will be apparent from the following detailed description when read in conjunction with the attached drawings.

### BRIEF DESCRIPTION OF THE DRAWINGS

For a more complete understanding of the disclosed system and method, reference should be made to the embodiments illustrated in greater detail in the accompanying drawings, wherein:

FIG. 1 is an exterior view of a first embodiment of a window with the internal anchor board-up system installed;

FIG. 2 is an exterior perspective view of the window in FIG. 1;

FIG. 3 is a side view of the window in FIG. 1;

FIG. 4 is an interior perspective view of the window in FIG. 1;

FIG. 5 is an interior view of the window in FIG. 1;

FIG. 6 is an exterior view of a second embodiment of a window with the internal anchor board-up system installed;

FIG. 7 is an exterior perspective view of the window in FIG. 6;

FIG. 8 is a side view of the window in FIG. 6;

FIG. 9 is an interior perspective view of another window equipped with the disclosed anchor and board-up system;

FIG. 10 is an interior plan view of the window in FIG. 9; and

FIG. 11 is a top sectional view of the window in FIGS. 9 and 10 and taken substantially along line A-A of FIG. 10.

It should be understood that the drawings are not necessarily to scale and that the disclosed embodiments are sometimes illustrated diagrammatically and in partial views. In certain instances, details which are not necessary for an understanding of the disclosed methods and systems or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

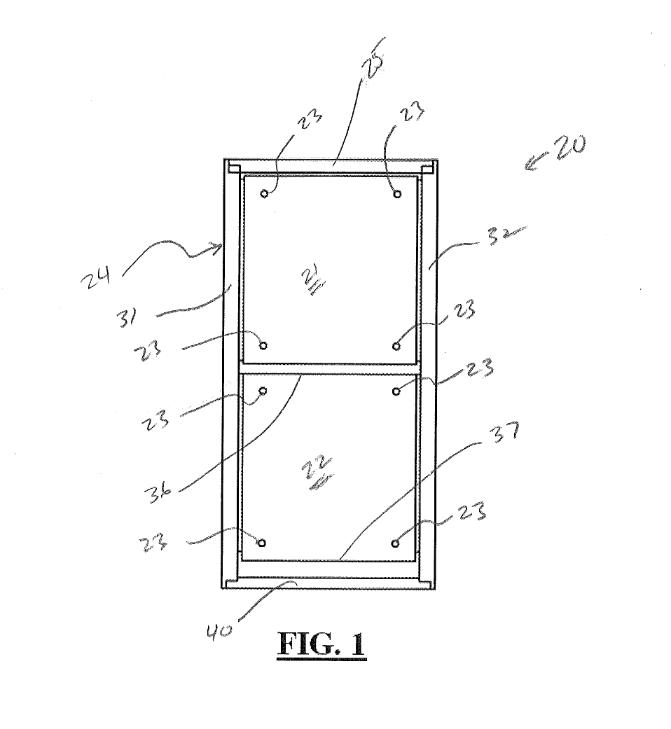

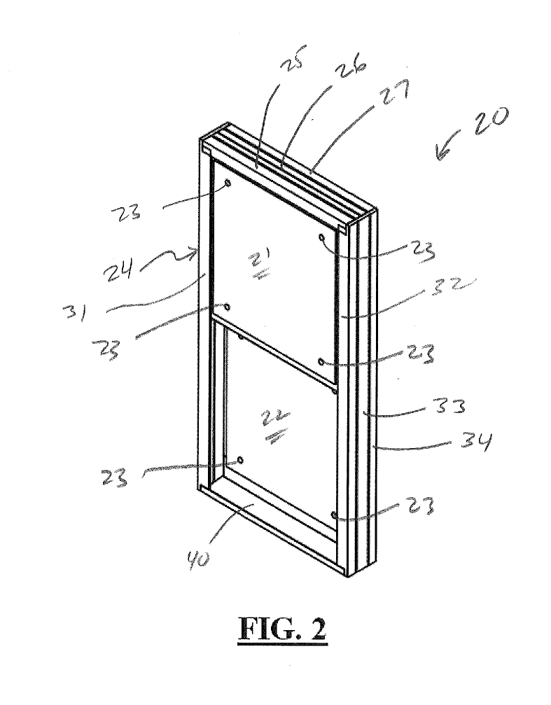

FIGS. 1-2 provide an exterior view of a window 20 equipped with two exterior covers 21, 22 that are fastened in place using a plurality of fasteners, such as bolts, shown at 23.

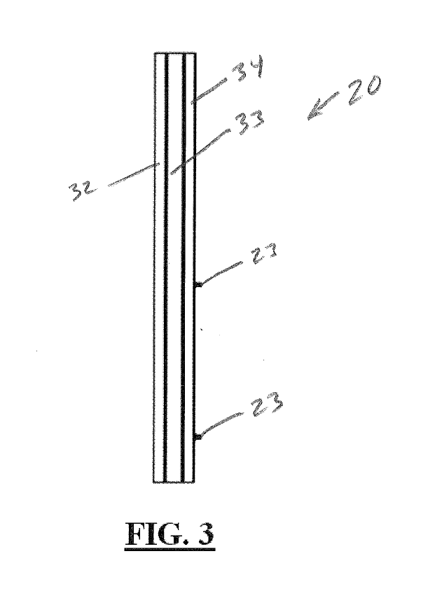

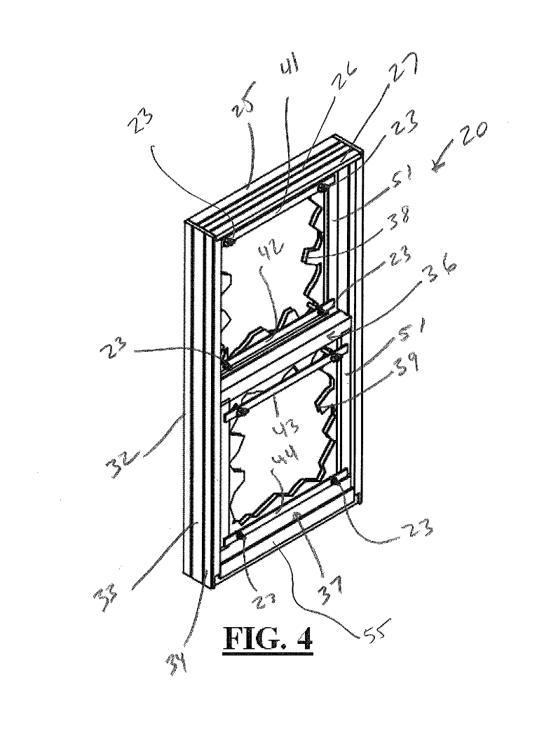

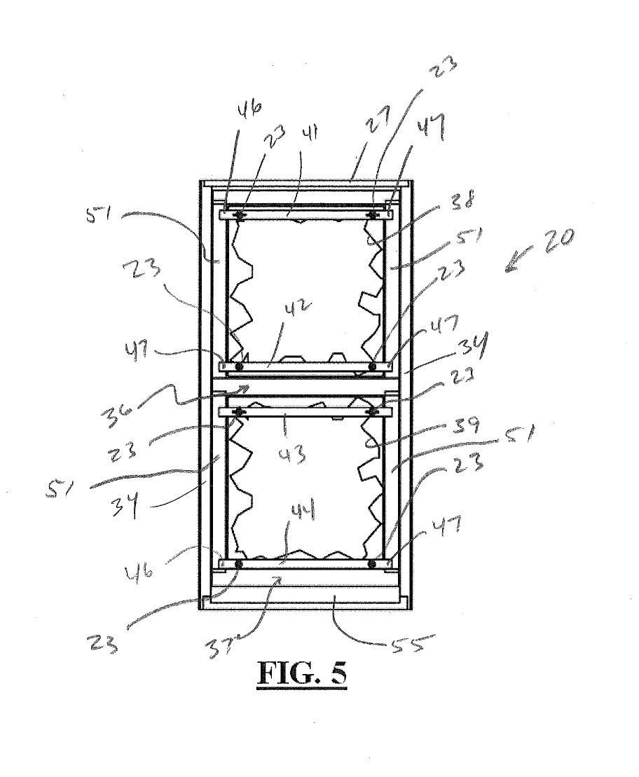

Structurally, the window 20 includes a frame 24 that includes an exterior head casing 25 (FIG. 1), a middle head casing 26 and an interior head casing 27. The frame 24 also includes exterior side casings 31, 32 and the exterior side casings 31, 32 are disposed along a middle side casing 33 and an interior side casing 34 as shown in FIGS. 2-3. The windowsill is shown at 40 in FIGS. 1-2. The apron is shown at 55 in FIGS. 4-5.

As shown in FIGS. 1-6, the window 20 may be a single or double hung window, meaning that one or both of the sashes 36, 37 move. In a double hung window, the upper sash 36 as well as the lower sash 37 move. In a single hung window, the lower sash 37 typically moves. As shown in FIGS. 4-5, both window panes 38, 39 have been broken. To secure the broken window 20, the exterior covers 21, 22 are held in place (preferably one at a time) as shown in FIGS. 1-2. Clamping beams 41-44 are then held in place (preferably one at a time) and fasteners 23 disposed at either opposing end 46, 47 of the beams 41-44 (see FIG. 5) are passed through openings in the exterior covers 21, 22 and openings in the clamping beams 41-44. Tightening the fasteners 23 provides a clamping force to secure the exterior covers 21, 22 in place.

The portions of the fasteners 23 disposed on the exterior side of the window 20 (FIGS. 1-2) may be a smooth head without a slot for a screw driver or without a geometrical shape to accommodate a wrench. The interior ends of the fasteners 23 as shown in FIGS. 4-5 may be equipped with a fictional tightening mechanism, such as a butterfly nut so that the tightening must be done from the inside the building but the situation where the fasteners 23 could be easily removed from outside of the building is avoided. In the embodiments illustrated in FIGS. 4-5, or clamping beams 41-44 are utilized in a horizontal and parallel orientation. The clamping beams 41-44 may also be used in a vertical orientation as well. Further, as shown in FIGS. 4-5, the clamping beams 41-44 are long enough to engage the side frame members 51 of the upper and lower sashes 36-37. Depending upon the design of the window 20, it may be desirable to have clamping beams 41-44 be longer so that they engage and press against the interior side casings 34.

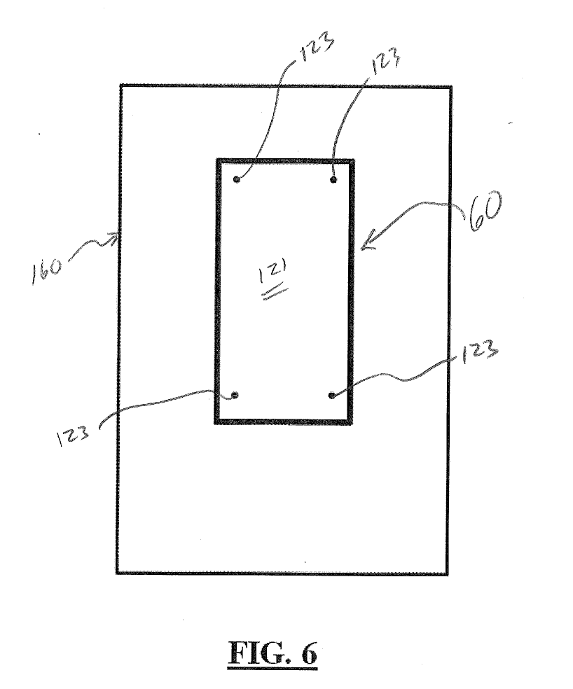

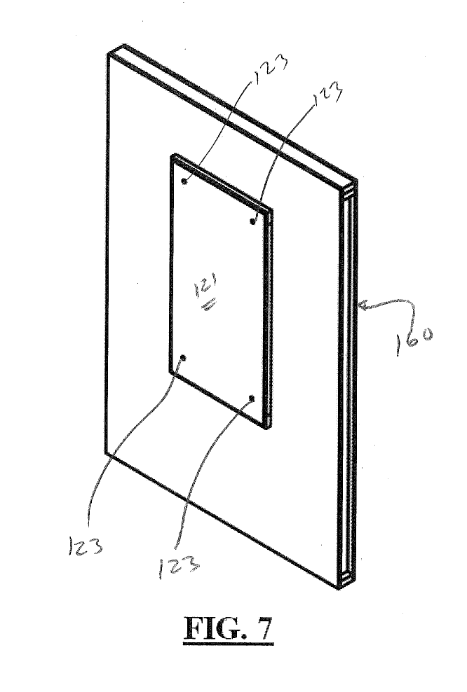

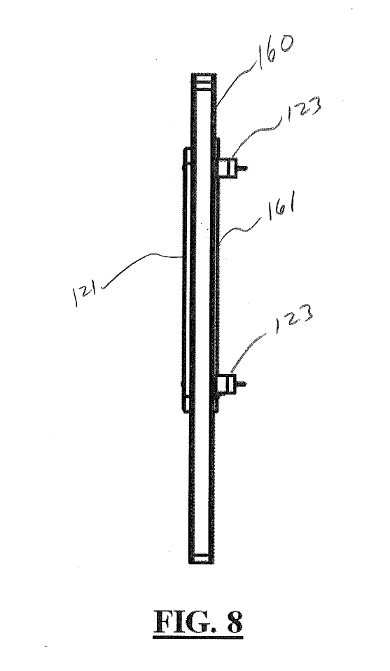

Returning to FIGS. 6-8, an alternative window 60 is illustrated equipped with a protected exterior cover 121 that is fastened in place with fasteners 123. The outer structure 160 may be a window or a door. For example, the exterior cover 121 could be covering a hole in a window pane or, as shown in FIGS. 7-8, the structure 160 is most likely a door equipped with a window 60. Returning to FIG. 8, a side view is shown with the exterior cover 121 held in place with fasteners 123.

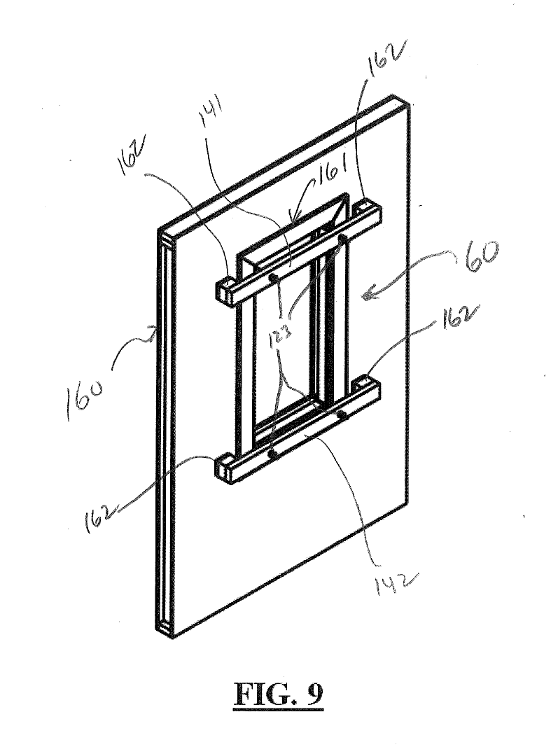

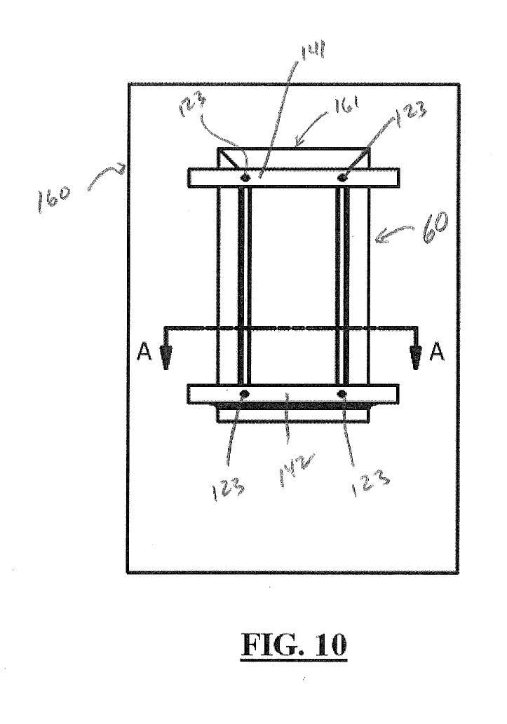

Turning to FIGS. 9-11, it will be noted that the window 60 as shown in FIG. 9 includes an encircling frame 161. Rather than damage the frame 161 by the clamping action of the clamping beams 141, 142, each clamping beam 141, 142 is equipped with a foot 162 that engages the door 160 (or other structure) thereby avoiding engagement with the clamping beams 141, 142 and the decorative frame 161.

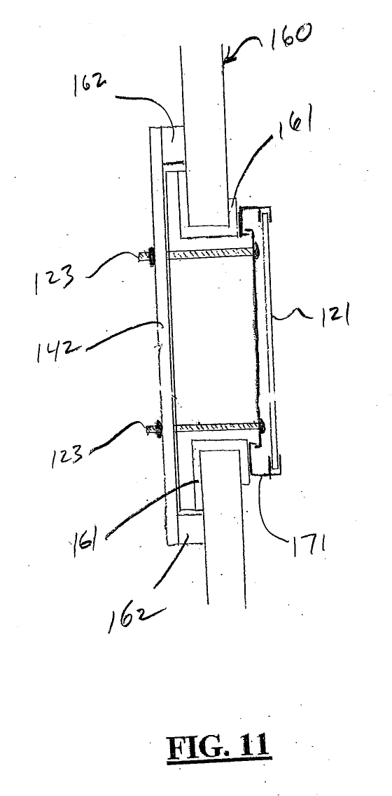

Further, referring to FIG. 11, the exterior cover 121 is held in place by a frame 171, which may extend around all four sides of the cover 121. The frame 171 is secured to the exterior of the door 160 by the exterior clamp bar 172, which is secured to the door 160 by the fasteners 123 and the interior clamping beam 142.

### INDUSTRIAL APPLICABILITY

The disclosed embodiments prevent or at least discourage the unauthorized entrance of an intruder into a building that has either been vacated or damaged. The disclosed embodiments may also be used for additional property protection during a natural disaster. The disclosed embodiments provide a minimally obstructed view from the interior of the property without creating damage to either the exterior or interior of the building.

There are three different types of windows: double-hung, casement and fixed. The disclosed embodiments will provide a secure cover-up with relatively minor differences between the three types.

The system comprises of three elements, the exterior window cover, the interior clamping beam and the connecting bolts between the cover and beam.

The exterior window cover is a clear polycarbonate sheet of between about ¼″ and about ½″ thickness depending upon the window opening size and location within the building. The overall size of the cover will be such that it will measure no more than ½″ less vertically and horizontally than that of the exterior window frame. A hole will be drilled into each of the four corners to allow a connecting bolt to pass through the cover. If desired, this window cover could be provided as a colored panel to eliminate visibility into the building.

The interior clamping beam may be about 2×4 (1.5″×3.5″) in size and may be made from wood, metal, or a composite product. A beam should be about 8″ greater in length than the horizontal measurement of the window casing from outside to outside. This length will allow for the placement of a foot with a rubber cushion to be attached at either end. The foot at either end will space the clamping beam beyond the thickness of the window casing, providing damage protection to the casing as well as the interior wall. Holes in the beam may line up with the holes horizontally in the exterior window cover.

The connecting bolts may be galvanized, non-slotted carriage bolts (e.g., ⅜″). The bolts should be of a length that will allow the bolt to pass through the exterior window cover and the interior clamping beam extending approximately 2″ beyond the beam for screwing a nut with a washer onto it. The length is variable due to the many variations of building construction. Bolt selection may be made during installation.

Double hung and casement window sashes would normally be removed from the window frame prior to installation. In the event that removal of the double hung window sashes is not possible, the sashes may be moved to the middle of the frame to allow the connecting bolts to pass through. Fixed windows will require drilling of holes through the window sash at each of the four corners.

What is claimed is:

1. A system for securing a window, comprising:
an exterior cover;
a first interior clamping beam; and
a plurality of fasteners passing through a window pane or opening in the event the window pane is broken and connecting the cover to the clamping beam.

2. The system of claim 1 wherein the exterior cover is sized to fit within a window frame.

3. The system of claim 1 wherein the exterior cover is sized to fit over a window frame.

4. The system of claim 1 further including a second clamping beam.

5. The system of claim 1 wherein the exterior cover is transparent.

6. The system of claim 4 wherein the first clamping beam and second clamping beam are disposed parallel to each other.

7. The system of claim 4 wherein the first clamping beam and second clamping beam are disposed parallel to each other and horizontally.

8. The system of claim 1 wherein the clamping beam includes two opposing ends, each end including a foot for engaging an interior surface and supporting the clamping beam above said interior surface.

9. A kit for boarding up a window, the kit comprising:
a first exterior cover;
a first interior clamping beam; and
a plurality of fasteners for passing through a window pane or an opening in the event the window pane is broken and connecting the cover to the clamping beam.

10. The kit of claim 9 wherein the exterior cover is sized to fit within a window frame.

11. The kit of claim 9 wherein the exterior cover is sized to fit over a window frame.

12. The kit of claim 9 further including a second clamping beam.

13. The kit of claim 9 wherein the exterior cover is transparent.

14. The kit of claim 12 wherein the first clamping beam and second clamping beam are disposed parallel to each other and horizontally.

15. The kit of claim 9 wherein the first clamping beam includes two opposing ends, each end including a foot for engaging an interior surface and supporting the clamping beam above said interior surface.

16. A method for boarding up a window opening, comprising:
providing an exterior cover sized to cover the window opening with exterior edges disposed within the window frame or sized to cover the window frame;
providing a first interior clamping beam sized to the wider or longer than the window opening;
placing the exterior cover over an exterior of the window;
placing the first interior clamping beam across the window;
connecting the exterior cover to the clamping beam with a plurality of fasteners.

17. The method of claim 16 further including providing a second interior clamping beam, placing the second clamping beam across an interior of the window and connecting the second clamping beam to the exterior cover.

18. The method of claim 17 wherein the first clamping beam and second clamping beam are disposed parallel to each other.

19. The method of claim 17 exterior cover is transparent.

20. The method of claim 16 wherein the first clamping beam includes two opposing ends and the method further includes tightening the fasteners so that at least a portion of a frame surrounding the window is clamped between the two opposing ends of the first clamping beam and the exterior cover.
